(19) United States
(12) Patent Application Publication
(10) Pub. No.: US 2009/0248412 A1
(43) Pub. Date: Oct. 1, 2009

(54) Association apparatus, association method, and recording medium

(75) Inventor: Nobuyuki Washio, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/318,429

(22) Filed: Dec. 29, 2008

(30) Foreign Application Priority Data
Mar. 27, 2008 (JP) 2008-084569

(51) Int. Cl. G10L 17/00

(52) U.S. Cl. 704/246; 704/E17.001

(57) ABSTRACT

There is provided an association apparatus for associating a plurality of voice data converted from voices produced by speakers, comprising: a word/phrase similarity deriving section which derives an appearance ratio of a common word/phrase that is common among the voice data based on a result of speech recognition processing on the voice data, as a word/phrase similarity; a speaker similarity deriving section which derives a result of comparing characteristics of voices extracted from the voice data, as a speaker similarity; an association degree deriving section which derives a possibility of the plurality of the voice data, which are associated with one another, based on the derived word/phrase similarity and the speaker similarity, as an association degree; and an association section which associates the plurality of the voice data with one another, the derived association degree of which is equal to or more than a preset threshold.

### CROSS-REFERENCE TO RELATED APPLICATION

This non-provisional application claims priority under 35 U.S.C. §119(a) on Patent Application No. 2008-084569 filed in Japan on Mar. 27, 2008, the entire contents of which are hereby incorporated by reference.

### FIELD

Embodiments discussed here relate to an association apparatus for associating plural voice data converted from voices produced by speakers, an association method using the association apparatus, and a recording medium storing a computer program that realizes the association apparatus.

### BACKGROUND

In an operation of dialoguing with a customer over a phone at a call center or the like, there are cases where a requirement involved in the dialogue is not completed in one call, and a plural number of times of calls are required. Examples of such cases include the case of making a request of a customer for confirmation of some kind in response to an inquiry from the customer, and the case of requiring a responder (operator) who responds to a customer to make a research such as confirmation with other person.

Further, there is also a case where voice data obtained by recording contents of calls are analyzed in order to grasp an operational performance status. In analysis of the contents of calls, when a plural number of times of calls are required for dealing with one requirement, the need arises for associating voice data, corresponding to a plural number of times of calls, with one another as a series of calls.

There has thus been proposed a technique of acquiring a caller number of a customer, managing personal information with the acquired caller number taken as a reference, and managing a requirement based on a keyword extracted by speech recognition processing on contents of calls. For example, see Japanese Patent No. 3450250.

In the case of managing a requirement based on a keyword extracted by speech recognition processing on calls, a keyword obtained as a result of speech recognition processing (speech recognition) and having the highest probability can be provided with a confidence of speech recognition processing. Voices included in the call are subjected to ambiguity of pronunciation of the speaker, a noise caused by a surrounding environment, an electronic noise caused by a call device, and the like. Therefore, an incorrect result of speech recognition can be obtained. For this reason, the keyword can be provided with a confidence of speech recognition. This is because, with the keyword provided with a confidence of speech recognition, the user can accept or reject the result of speech recognition based on the height of the confidence. Further, the user can avoid a problem due to incorrect speech recognition. As a method for deriving a confidence of speech recognition, for example, a competition model system has been proposed. In this method, a ratio of probabilities between a model used in speech recognition and a completion model is calculated, and confidence is calculated from the calculated ratio. As another method provided has been a system of calculating confidence in speech unit as one acoustic unit sandwiched between two silent sections during a call, or in sentence unit. For example, refer to Japanese Laid-Open Patent Publication 2007-240589, entire contents of which are incorporated by reference.

### SUMMARY

In the apparatus disclosed in foregoing Japanese Patent No. 3450250, acquirement of a caller number is presupposed. Therefore, the apparatus is not applied to a call from an unnotified number, and the like. Further, in a case where calls are received from the same caller number, the apparatus does not differentiate different speakers.

There is provided an association apparatus according to an aspect, for associating plural voice data converted from voices produced by speakers, including: a word/phrase similarity deriving section which derives a numeric value in regard to an appearance ratio of a common word/phrase that is common among the voice data as a common similarity based on a result of speech recognition processing on the voice data; a speaker similarity deriving section which derives a similarity indicating a result of comparing characteristics of respective voices extracted from the voice data as a speaker similarity; an association degree deriving section which derives an association degree indicating the possibility of plural voice data being associated with one another based on the derived word/phrase similarity and speaker similarity; and an association section which associates plural voice data with one another, the derived association degree of which is not smaller than a previously set threshold.

Additional objects and advantages of embodiments will be set forth in part in the description which follows, and in part will be obvious from the description, or may be learned by practice of the embodiments. The objects and advantages of the embodiments will be realized and attained by means of the elements and combinations particularly pointed out in the appended claims. It is to be understood that both the foregoing general description and the foregoing general description are exemplary and explanatory only and are not restrictive of the embodiments, as claimed.

### BRIEF DESCRIPTION OF THE DRAWINGS

FIG. 1 is a block diagram showing a constitutional example of hardware of an association apparatus of an embodiment;

FIG. 2 is an explanatory view conceptually showing an example of a recorded content of a voice database provided in the association apparatus of the present embodiment;

FIG. 3 is a functional block diagram showing a functional constitutional example of the association apparatus of the present embodiment;

FIG. 4 is a flowchart showing an example of basic processing performed by the association apparatus of the present embodiment;

FIG. 5 is an explanatory view showing an example of a result of association outputted by the association apparatus of the present embodiment;

FIG. 6 is a graph showing an example of deriving a weight in requirement similarity deriving processing performed by the association apparatus of the present embodiment;

FIG. 7 is an explanatory view showing an example of a list presenting synonyms in the requirement similarity deriving processing performed by the association apparatus of the present embodiment;

FIG. 8 is a flowchart showing an example of the requirement similarity deriving processing performed by the association apparatus of the present embodiment;

FIGS. 9A and 9B are diagrams each showing a specific example of the requirement similarity deriving processing performed by the association apparatus of the present embodiment;

FIG. 10 is a flowchart showing an example of speaker similarity deriving processing performed by the association apparatus of the present embodiment;

FIG. 11 is a graph showing an example of a time change of a penalty function in the association degree deriving processing performed by the association apparatus of the present embodiment;

FIG. 12 is a diagram showing a specific example of time used for the penalty function in the association degree deriving processing performed by the association apparatus of the present embodiment; and

FIG. 13 is a graph showing an example of a time change of a penalty function in the association degree deriving processing performed by the association apparatus of the present embodiment.

### DESCRIPTION OF EMBODIMENTS

In the following, the present technique is described in detail based on drawings showing its embodiment. The association apparatus according to the embodiment is an apparatus that detects association of plural voice data converted from voices produced by speakers, and further performs recording and outputting after the association. The plural voice data to be associated are, for example, voice data in regard to respective calls when, in an operation of dialoguing with a customer over a phone at a call center or the like, a requirement involved in the dialogue is not completed in one call, and a plural number of times of calls are required. Namely, the association apparatus of the present embodiment performs association by taking calls from the same customer on the same requirement as a series of calls.

In the apparatus disclosed in foregoing Japanese Patent No. 3450250, acquirement of a caller number is presupposed. Therefore, the apparatus is not applied to a call from an unnotified number, and the like. Further, in a case where calls are received from the same caller number, the apparatus does not differentiate different speakers.

It is an object of the embodiments as discussed below to provide an association apparatus capable of presuming voice data being a series of call irrespective of caller numbers, an association method using the association apparatus, and a recording medium storing a computer program that realizes the association apparatus. For achieving this object, based on a result of speech recognition processing on voice data, a word/phrase similarity based on an appearance ratio of a common word/phrase common among the voice data is derived. Further, based on characteristics of voices extracted from the voice data, a speaker similarity is derived. Subsequently, based on the derived word/phrase similarity and speaker similarity, an association degree is derived, and based on the derived association degree, it is determined whether or not to associate plural voice data with one another as a series of calls.

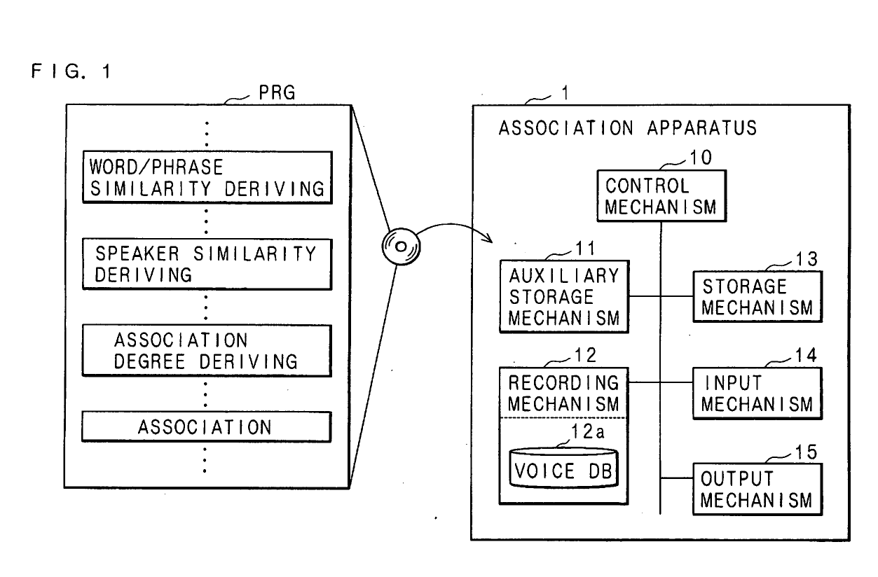

FIG. 1 is a block diagram showing a constitutional example of hardware of an association apparatus of an embodiment. An association apparatus 1 shown in FIG. 1 is configured using a computer such as a personal computer. The association apparatus 1 includes: a control mechanism 10, an auxiliary storage mechanism 11, a recording mechanism 12, and a storage mechanism 13. The control mechanism 10 is a mechanism such as a CPU that controls the whole of the apparatus. The auxiliary storage mechanism 11 is a mechanism such as a CD-ROM drive that reads a variety of information from a recording medium such as a CD-ROM that records a variety of information like programs including a computer program PRG of the present embodiment, and data. The recording mechanism 12 is a mechanism such as a hard disk that records a variety of information read by the auxiliary storage mechanism 11. The storage mechanism 13 is a mechanism such as an RAM that stores temporarily generated information. The computer program PRG recorded in the recording mechanism 12 is stored into the storage mechanism 13, and executed by control of the control mechanism 10, whereby the computer operates as the association apparatus 1.

Further, the association apparatus 1 includes an input mechanism 14, such as a mouse and keyboard, and an output mechanism 15, such as a monitor and a printer.

Moreover, part of a recording region of the recording mechanism 12 in the association apparatus 1 is used as a voice database (voice DB) 12a that records voice data. It is to be noted that the part of the recording region of the recording mechanism 12 may not be used as the voice database 12a, but another apparatus connected to the association apparatus 1 may be used as the voice database 12a.

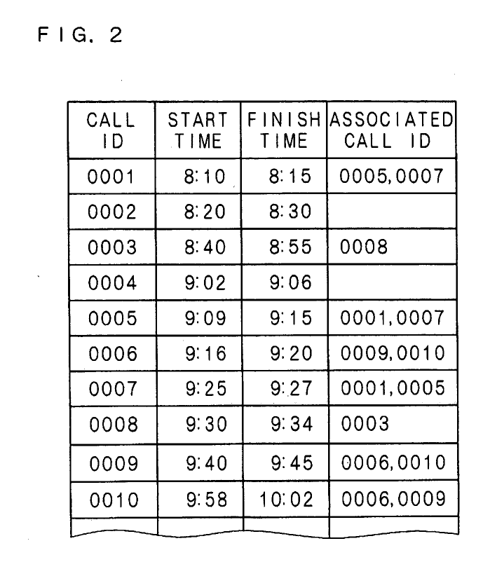

In the voice database 12a, voice data can be recorded in a variety of forms. For example, voice data in regard to each call can be recorded as an independent file. Further, for example, voice data can be recorded as voice data including plural calls and as data that specifies each call included in the voice data. The voice data including plural calls is, for example, data recorded in a day using one telephone. The data that specifies each call included in the voice data is data indicating the start time and the finish time of each call. FIG. 2 is an explanatory view conceptually showing an example of a recorded content of a voice database 12a provided in the association apparatus 1 of the present embodiment. FIG. 2 shows an example of a recording system of data that specifies calls in the case of constituting the voice database 12a as data specifying voice data of each telephone and each call included in the voice data. A call ID is provided as data specifying each call included in recorded voice data of each telephone, and in correspondence with the call ID, a variety of items such as the start time, the finish time, and an associated call ID, are recorded in record unit. The start time and the finish time indicate the start time and the finish time of a section corresponding to the call in the original voice data. It should be noted that each time may be an absolute actual time, or a relative time with the first time of the original voice data set to “0:00”. The associated call ID is an ID that specifies a call associated with the call ID by processing of the association apparatus 1. In the example shown in FIG. 2, calls with call IDs of “0001”, “0005” and “0007” are associated with one another as calls indicating a series of calls. It is to be noted that as described above, the respective calls may be recorded as voice data in a system such as a WAV file, and for example in that case, the voice data corresponding to the call ID “0001” may be provided with a file name such as “0001.wav”.

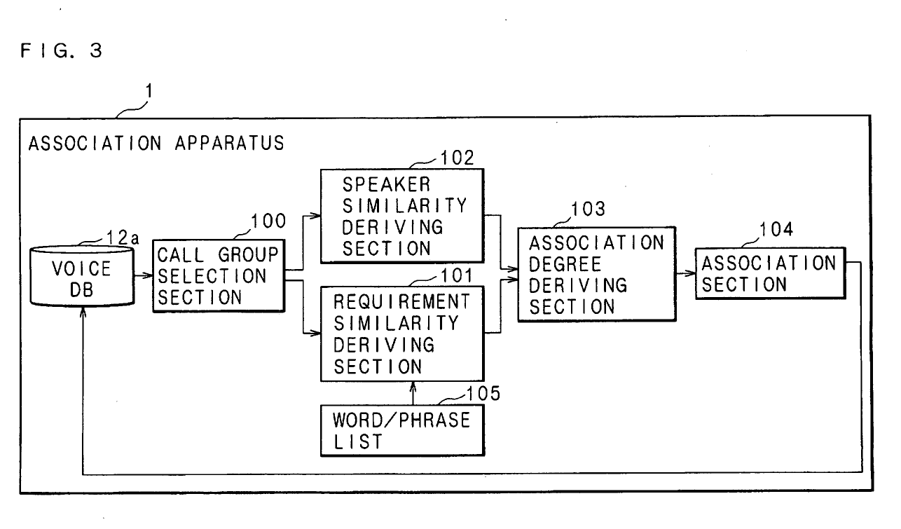

FIG. 3 is a block diagram showing a functional constitutional example of the association apparatus 1 of the present embodiment. The association apparatus 1 executes the computer program PRG of the present embodiment recorded in the recording mechanism 12 based on control of the control mechanism 10, to activate a variety of functions such as a call group selecting section 100, a requirement similarity deriving section 101, a speaker similarity deriving section 102, an association degree deriving section 103, an association section 104 and a word/phrase list 105.

The call group selecting section 100 is a program module for executing processing such as selection of voice data in regard to plural calls, which is determining association of voice data recorded in the voice database 12a.

The requirement similarity deriving section (word/phrase similarity deriving section) 101 is a program module for executing processing such as derivation of a requirement similarity (word/phrase similarity) indicating a similarity of requirements of call contents in voice data in regard to the plural calls selected by the call group selecting section 100.

The speaker similarity deriving section 102 is a program module for executing processing such as derivation of a speaker similarity (word/phrase similarity) indicating a similarity of speakers of call contents in voice data in regard to the plural calls selected by the call group selecting section 100.

The association degree deriving section 103 is a program module is a program module for executing processing such as derivation of the possibility of association of voice data in regard to the plural calls selected by the call group selecting section 100 based on the requirement similarity derived by the requirement similarity deriving section 101 and the speaker similarity derived by the speaker similarity deriving section 102.

The association section 104 is a program module for executing processing such as recording, outputting, and the like in association with voice data in regard to calls based on the association degree derived by the association-degree deriving section 103.

The word/phrase list 105 records word/phrases that have effects on the respective processing such as determination of a requirement similarity by the requirement similarity deriving section 101, derivation of an association degree by the association degree deriving section 103, and the like. It is to be noted that examples and usages of the words/phrases recorded in the word/phrase list 105 are described in subsequent descriptions of the processing on a case-by-case basis.

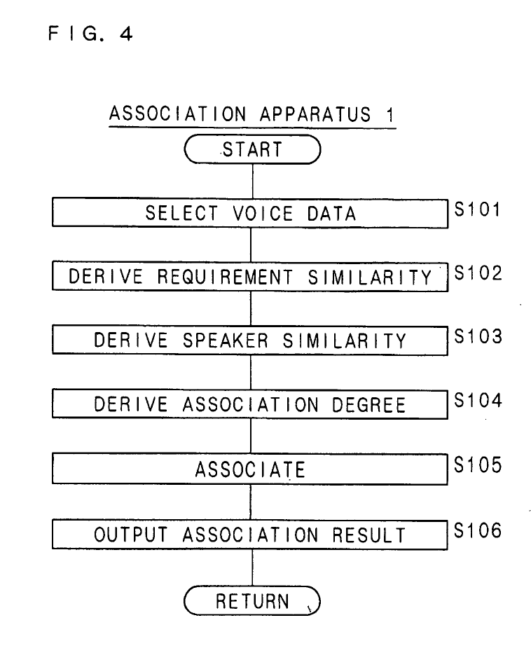

Next, the processing performed by the association apparatus 1 of the present embodiment is described. FIG. 4 is a flowchart showing an example of basic processing performed by the association apparatus 1 of the present embodiment. The association apparatus 1 selects plural voice data from the voice database 12a by the processing of the call group selecting section 100 based on control of the control mechanism 10 that executes the computer program PRG (S101). In the subsequent description, the voice data means voice data indicating a voice in call unit. Hence, for example when voice data including plural calls are recorded in the voice database 12a, voice data in the subsequent description indicates voice data in regard to an individual call. Association of plural voice data selected in Step S101 is detected in the subsequent processing. For example, voice data with a call ID of “0001” and voice data with a call ID of “0002” are selected and the association thereof is detected, and subsequently, the voice data with the call ID of “0001” and voice data with a call ID of “0003” are selected to detect the association thereof. This processing is repeated so that the association between the voice data with the call ID of “0001” and other voice data can be detected. Moreover, the association between the voice data with the call ID of “0002” and other voice data is detected, and the association between the voice data with the call ID of “0003” and other voice data is detected, so that the association of all voice data can be detected. It is to be noted that three voice data or more may be selected at once, and the association among them may be detected.

Voice data of one call ID has a non-voice section as a data region including no voice, in which speakers do not talk. Further, the voice data has a voice section, in which the speakers converse with each other. Plural voice sections as thus described may be included in the voice data. In this case, the non-voice section is intercalated among the plural voice section. One voice section includes one or plural words/phrases produced by a speaker. It is possible that the one voice section includes a common word/phrase that is common with a word/phrase produced by a speaker which is included in voice data of another call ID different from the voice data of the one call ID including the one voice section. The start point of the voice section is defined as a time point between the non-voice sections sandwiching the voice section and the voice section. Other than that, in the case of the voice section starting from the start point of the voice data, the start point of the voice section is defined as the start point of the voice data. A time period between the start point of the voice section included in the voice data (singular) and a time point at which a common word/phrase appears can be defined as a elapsed time from the start time of voice data of one call ID until appearance of a requirement word/phrase (common word/phrase).

By the processing of the requirement similarity deriving section 101 based on control of the control mechanism 10, the association apparatus 1 performs speech recognition processing on plural voice data selected by the call group selecting section 100, and based on a result of the speech recognition processing, the association apparatus 1 derives a numeric value in regard to an appearance ratio of a requirement word/phrase that is common among each voice data and concerns a content of a requirement as a requirement similarity (S102). In Step S102, the requirement word/phrase concerning the content of the requirement is a word/phrase indicated in the word/phrase list 105.

By the processing of the speaker similarity deriving section 102 based on control of the control mechanism 10, the association apparatus 1 extracts characteristics of respective voices from the plural voice data selected by the call group selecting section 100, and derives a similarity indicating a result of the extracted characteristics (S103).

By the processing of the association degree deriving section 103 based on control of the control mechanism 10, the association apparatus 1 derives an association degree indicating the possibility of selected plural voice data being associated with one another based on the requirement similarity derived by the requirement similarity deriving section 101 and the speaker similarity derived by the speaker similarity deriving section 102 (S104).

By the processing of the association section 104 based on control of the control mechanism 10, the association apparatus 1 associates the selected plural voice data with one another when the association degree derived by the association-degree deriving section 103 is not smaller than a previously set threshold (S105), and executes outputting of a result of the association, such as recording the result into the voice database 12a (S106). In Step S105, when the association degree is smaller than the threshold, the selected plural voice data are not associated with one another. Recording in Step S106 is performed by recording the voice data as associated call IDs as shown in FIG. 2. In addition, although the mode of recording the associated voice data into the voice database 12a so as to output the association result was described in Step S106, a variety of modes of outputs can be performed, such a method other than the above like display of the associated data on the output mechanism 15 as the monitor. The association apparatus 1 then executes the processing of Steps S101 to S106 on all groups of voice data as candidates to be associated.

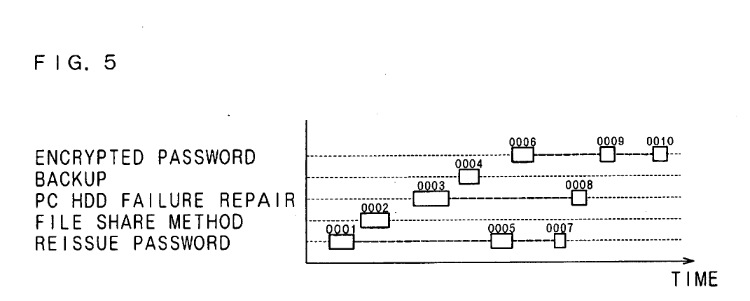

The result of association recorded in the voice database 12a can be outputted in a variety of forms. FIG. 5 is an explanatory view showing an example of a result of association outputted by the association apparatus 1 of the present embodiment. In FIG. 5, with passage of time taken as the axis of abscissas, and contents of association taken as the axis of ordinate, the relation therebetween is shown in graphical form. Rectangles in the graph of FIG. 5 indicate calls in regard to voice data, and the figure over each rectangle indicates a call ID of voice data. The length and the position of the rectangle in the lateral direction indicate a time period and the time in regard to the call. A broken line connecting the rectangles indicates that the calls are associated with each other. The word/phrase indicated on the axis of ordinate side indicates a content of a requirement corresponding to a requirement word/phrase used in deriving a requirement similarity. For example, voice data with call IDs of “0001”, “0005” and “0007” are associated with one another based on the content of requirement of “password reissuance”. The detection result shown in FIG. 5 is, for example, displayed on the output mechanism 15 as the monitor, so that the user having viewed the output result can grasp the association and contents of each voice data. In addition, if it is possible to determine a calling direction of each voice data, that is, whether a call is involved in a call-out from the customer side or a call-out from the operator side, the voice data may be outputted in a display method where such calling directions are clearly indicated.

The forgoing basic processing is used in such an application that the association apparatus 1 of the present embodiment appropriately associates plural voice data with one another, and thereafter classifies the data. However, the basic processing is not limited to such a form, but can be developed into a variety of figurations. The basic processing can be developed into a variety of figurations such as using the processing in an application of selecting voice data that can be associated out of previously recorded plural voice data with respect to one voice data, and further, an application of extracting voice data associated with a voice during a call

Next, each processing executed during the basis processing is described. First, the requirement similarity calculating processing executed as Step S102 of the basis processing is described. The subsequent description is given on the assumption that voice data of a call A and voice data of a call B were selected in Step S101 of the basis processing, and a requirement appearance ratio of the voice data of the call A and the voice data of the call B is to be derived.

By the processing of the speaker similarity deriving section 102, the association apparatus 1 performs speech recognition processing on the voice data, and based on a result of the speech recognition processing, the association apparatus 1 derives a numeric value in regard to an appearance ratio of a requirement word/phrase that is common between the voice data of the call A and the voice data of the call B and concerns a content of a requirement as a requirement similarity.

A keyword spotting system in generally widespread use is used in the speech recognition processing. However, the system used in the processing is not limited to the keyword spotting method, but a variety of methods can be used, such as a method of performing keyword search on a letter string as a recognition result of all-sentence transcription system called dictation, to extract a keyword. As the keyword detected by the keyword spotting method and the keyword in regard to the all-sentence transcription system, requirement words/phrases previously recorded in the word/phrase list 105 are used. The “requirement words/phrases” are words/phrases associated with requirements such as “personal computer”, “hard disk” and “breakdown”, as well as words/phrases associated with explanation of requirements, such as “yesterday” and “earlier”. It is to be noted that only words/phrases associated with requirements may be treated as the requirement words/phrases.

The requirement similarity (word/phrase similarity) is derived by the following expression (1) using the number Kc of common words/phrases which indicates the number of words/phrases that appear both in the voice data of the call A and the voice data of the call B, and the number Kn of total words/phrases which indicates the number of words/phrases that appear at least either the voice data of the call A or the voice data of the call B. It is to be noted that in counting the number Kc of common words/phrases and the number Kn of total words/phrases, when the identical word/phrase appears a plural number of times, it is counted as one in each appearance. A requirement similarity Ry derived in such a manner is a value not smaller than 0 and not larger than 1.

Ry=2×Kc/Kn (1)

where

Ry: requirement similarity,

Kc: the number of common words/phrases, and

Kn: the number of total words/phrases.

It should be noted that the expression (1) is satisfied when the number Kn of total words/phrases is a counting number. When the number Kn of total words/phrases is 0, the requirement similarity Ry is treated as 0.

The foregoing requirement similarity deriving processing can further be adjusted in a variety of manners, so as to enhance the confidence of the derived requirement similarity Ry. The adjustment for enhancing the confidence of the requirement similarity Ry is described. The requirement word/phrase in regard to derivation of the requirement similarity Ry is a result recognized by speech recognition processing, and hence the recognition result may include an error. Therefore, the requirement similarity Ry is derived by use of the following expression (2) adjusted based on the confidence of the speech recognition processing, so that the confidence of the requirement similarity Ry can be enhanced.

$$\begin{matrix}Ry = 2 \times {\sum }_{i = 1}^{Kc} ( {C}_{Ai} \times {C}_{Bi} ) / Kn ( Kn > 0 ) \\ = 0 ( Kn = 0 )\end{matrix} \qquad ( 2 )$$

WHERE, C_{Ai}: CONFIDENCE OF RECOGNITION OF ith COMMON WORD/PHRASE IN VOICE DATA OF CALLA
C_{Bi}: CONFIDENCE OF RECOGNITION OF ith COMMON WORD/PHRASE IN VOICE DATA OF CALL B

It is to be noted that the expression (2) is satisfied when the number Kn of total words/phrases is a counting number. When the number Kn of total words/phrases is 0, the requirement similarity Ry is treated as 0. Moreover, when the same common word/phrase appears many times in one call, the requirement similarity Ry may be derived using the highest confidence, and further, adjustment may be made such that the confidence increases in accordance with the number of appearances.

Further, since voice data are converted from calls at the call center, a word/phrase deeply related to an original requirement is likely to appear at the beginning of the call, for example within 30 seconds after the start of the call. Therefore, the requirement similarity Ry is derived by use of the following expression (3) adjusted by the requirement word/phrase having appeared by a weight W(t) based on the time t from the start of a dialogue until the appearance of the word/phrase, so that the confidence of the requirement similarity Ry can be enhanced.

$$\begin{matrix}Ry = 2 \times {\sum }_{i = 1}^{Kc} ( W ( {T}_{Ai} ) \times {C}_{Ai} \times W ( {T}_{Bj ( i )} ) \times {C}_{Bj ( i )} ) / \\ ( {\sum }_{i = 1}^{Ka} ( W ( {T}_{Ai} ) \times {C}_{Ai} ) + {\sum }_{i = 1}^{Kb} ( W ( {T}_{Bi} ) \times {C}_{Bi} ) ) ( Kn > 0 ) \\ = 0 ( Kn = 0 )\end{matrix} \qquad ( 3 )$$

WHERE, W(t): WEIGHT BASED ON TIME ELAPSE t FROM START TIME POINT OF CALL
T_{Ai}: TIME ELAPSE FROM START TIME POINT OF VOICE DATA CONCERNING CALL A TO APPEARANCE TIME POINT OF ith REQUIREMENT WORD/PHRASE
T_{Bi}: TIME ELAPSE FROM START TIME POINT OF VOICE DATA CONCERNING CALL B TO APPEARANCE TIME POINT OF ith REQUIREMENT WORD/PHRASE
Bj(i): REQUIREMENT WORD/PHRASE IN VOICE DATA CONCERNING CALL B, THE WORD/PHRASE BEING COMMON WORD/PHRASE AS WORD/PHRASE Ai

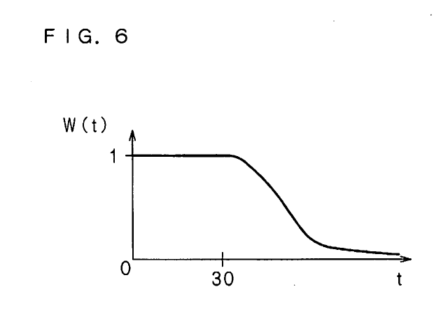

FIG. 6 is a graph showing an example of deriving the weight W(t) in the requirement similarity deriving processing performed by the association apparatus 1 of the present embodiment. In FIG. 6, with elapsed time t taken as the axis of abscissas, and the weight W(t) taken as the axis of ordinate, the relation therebetween is shown. The weight W(t) used in the expression (3) can be derived from the elapsed time t for example by use of the graph shown in FIG. 6,. As apparent from FIG. 6, a large weight is given to a requirement word/phrase that appears until the elapsed time t reaches 30 seconds, and a weight given thereafter sharply decreases. As thus described, based on the assumption that the requirement word/phrase that appeared at the early stage from the start of the dialogue, for example within 30 seconds, is deeply related to the original requirement, the requirement similarity Ry is adjusted in accordance with the time until the requirement word/phrase appears, so that the confidence of the requirement similarity Ry can be enhanced.

Moreover, since the requirement word/phrase in regard to derivation of the requirement similarity Ry is a result of recognition by the speech recognition processing, requirement words/phrases in a relationship such as “AT”, “computer” and “personal computer”, namely synonyms, are determined as different requirement words/phrases. Therefore, the requirement similarity Ry can be adjusted based on the synonyms, so as to enhance the confidence of the requirement similarity Ry.

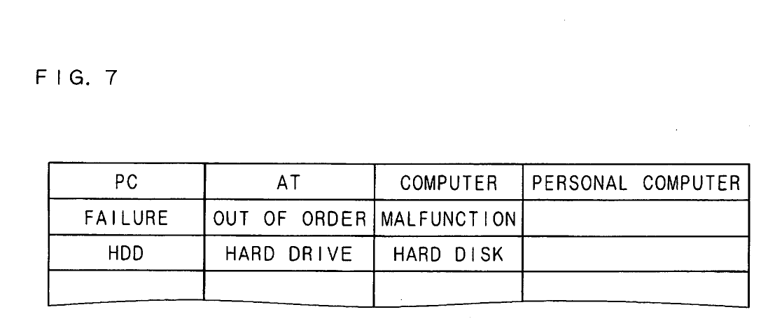

FIG. 7 is an explanatory view showing an example of a list presenting synonyms in the requirement similarity deriving processing performed by the association apparatus 1 of the present embodiment. As shown in FIG. 7, for example, “AT”, “computer” and “personal computer” are regarded as the same requirement word/phrase that can be notated as “PC” and the number Kc of common words/phrases is counted, so that the confidence of the requirement similarity Ry can be enhanced. The list showing such synonyms is mounted on the association apparatus 1 as part of the word/phrase list 105.

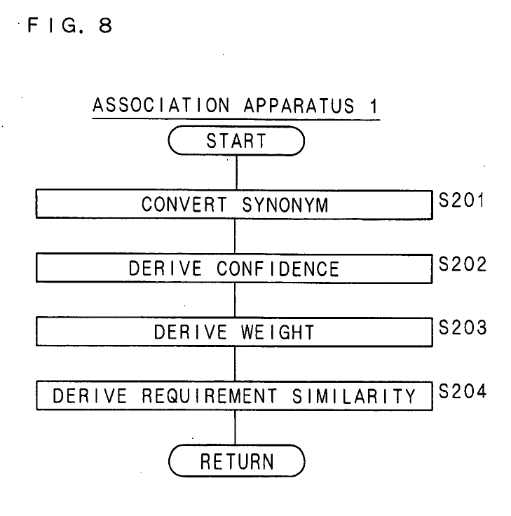

FIG. 8 is a flowchart showing an example of the requirement similarity deriving processing performed by the association apparatus 1 of the present embodiment. The processing of calculating the requirement similarity adjusted based on a variety of requirements as described above is described. By the processing of the requirement similarity deriving section 101 based on control of the control mechanism 10, the association apparatus 1 performs conversion processing of synonyms on a result of recognition processing on the voice data of the call A and the voice data of the call B (S201). The conversion processing of synonyms is performed using the list shown in FIG. 7. For example “AT”, “computer” and “personal computer” are converted into “PC”. In addition, from the viewpoint of the high possibility that one speaker uses the same word/phrase with respect to one object, when the requirement similarity in accordance with synonyms is high, adjustment of making an ultimately derived association degree small may be performed.

The association apparatus 1 derives the confidence of each requirement word/phrase by the processing of the requirement similarity deriving section 101 based on control of the control mechanism 10 (S202), and further derives a weight of each requirement word/phrase (S203). The confidence of Step S202 is confidence toward speech recognition, and a value is used which was derived at the time of the speech recognition processing by use of an already proposed common technique. The weight of S203 is derived based on the appearance ratio of the requirement word/phrase.

The association apparatus 1 then derives the requirement similarity Ry (S204) by the processing of the requirement similarity deriving section 101 based on control of the control mechanism 10 (S204). In Step S204, the requirement similarity Ry is derived using the foregoing expression (3). The requirement similarity Ry derived in such a manner is closer to 1 in the section with a large weight due to the appearance time when more requirement words/phrases agree with one another and the confidence is higher at the time of speech recognition processing on the requirement words/phrases. In addition, the similarity among the requirement words/phrases may not be derived, but a table associating requirement words/phrases with contents of requirements may be previously prepared, and a similarity of contents of a requirement associated with the requirement words/phrases may be derived.

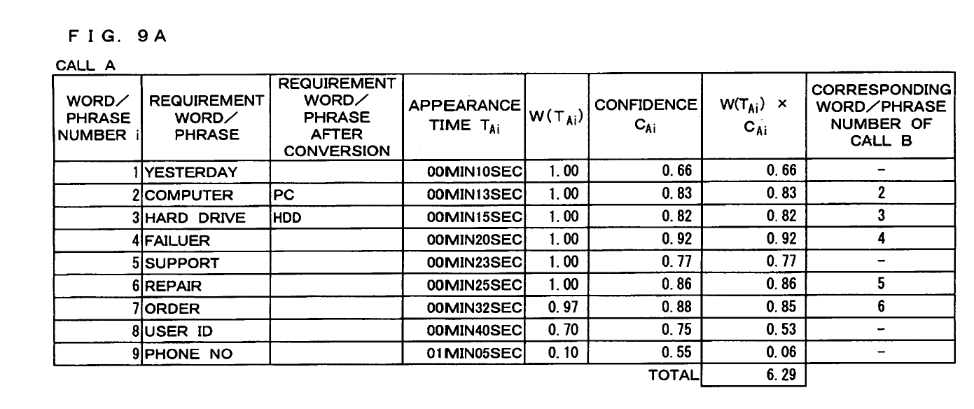

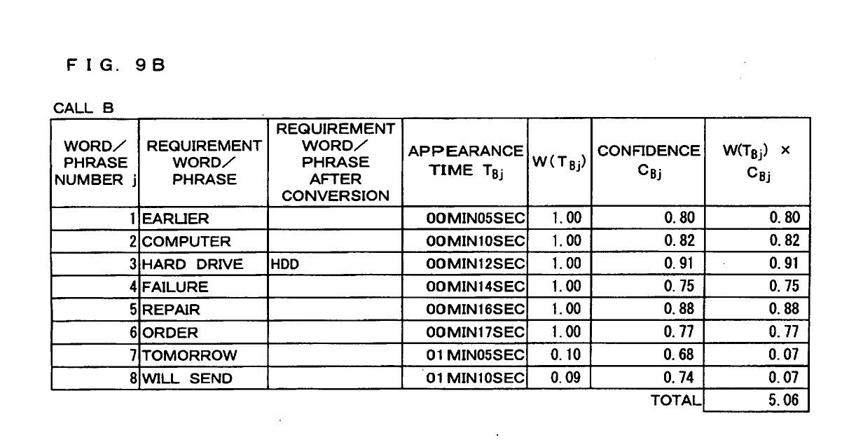

FIGS. 9A and 9B are diagrams each showing a specific example of the requirement similarity deriving processing performed by the association apparatus 1 of the present embodiment. FIG. 9A shows, in record system, information regarding requirement words/phrases based on a result of speech recognition processing on the voice data of the call A. The information regarding the requirement words/phrases are shown with respect to each of items including: a word/phrase number i, a requirement word/phrase, a requirement word/phrase after conversion, appearance time T_{Ai}, a weight W (T_{Ai}), a confidence C_{Ai}, W (T_{Ai})×C_{Ai}, and a word/phrase number j of the corresponding call B. FIG. 9B shows, in record system, information regarding requirement words/phrases based on a result of speech recognition processing on the voice data of the call B. The information regarding the requirement words/phrases are shown with respect to each of items including: a word/phrase number i, a requirement word/phrase, a requirement word/phrase after conversion, appearance time T_{Bj}, a weight W (T_{Bj}), a confidence C_{Bj}, and W (T_{Bj})×C_{Bj}.

In the example shown in FIGS. 9A and 9B, the requirement similarity Ry calculated using the foregoing expression (3) is as follows. It is to be noted that the number Kn of total words/phrases=9+8=17, namely, Kn>0.

Ry=2×{(1×0.83×1×0.82)+(1×0.82×1×0.91)+(1×0.86×1×0.88)+(0.97×0.88×1×0.77)}/(6.29+5.06)=0.622

In such a manner, the requirement similarity calculating processing is executed.

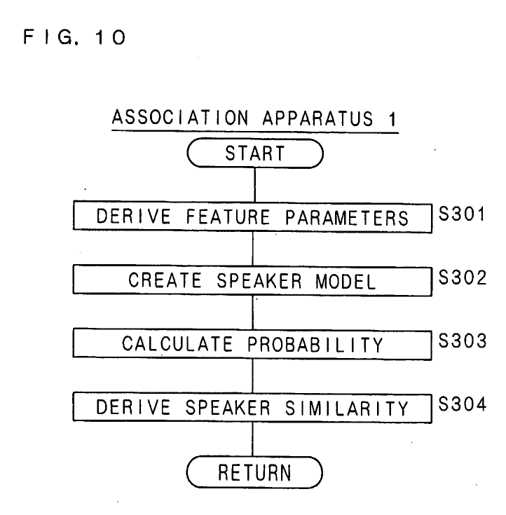

Next described is the speaker similarity calculating processing that is executed as Step S103 of the basis processing. FIG. 10 is a flowchart showing an example of the speaker similarity deriving processing performed by the association apparatus 1 of the present embodiment. It should be noted that the subsequent description is given on the assumption that the voice data of the call A and the voice data of the call B were selected in Step S101 of the basis processing and a speaker similarity of the voice data of the call A and the voice data of the call B is to be derived.

By the processing of the speaker similarity deriving section 102 based on control of the control mechanism 10, the association apparatus 1 derives feature parameters obtained by digitalizing physical characteristics of the voice data of the call A and the voice data of the call B (S301). The feature parameters in Step S301 is also be referred to as a characteristic parameter, a voice parameter, a feature parameter, or the like, and is used in the mode of a vector, a matrix, or the like. As the feature parameters derived in Step S301 typically used are, for example, Mel-Frequency Cepstrum Coefficient (MFCC), Bark Frequency Cepstrum Coefficient (BFCC), Linear Prediction filter Coefficients (LPC), LPC cepstral, Perceptual Linear Prediction cepstrum (PLP), Power, and a combination of primary or secondary regression coefficients of these feature parameters. Such feature parameters may further be combined with normalization processing or noise removal processing of RelAtive SpecTrA (RASTA), Differential Mel Frequency Cepstrum Coefficient (DMFCC), Cepstrum Mean Normalization (CMN), Spectral Subtraction (SS), or the like.

By the processing of the speaker similarity deriving section 102 under control of the control mechanism 10, the association apparatus 1 generates a speaker model of the call A and a speaker model of the call B in accordance with model estimation, such as the most probability estimation, based on the derived feature parameters of the voice data of the call A and the voice data of the call B (S302). For generation of the speaker model in Step S302, it is possible to use a model presumption technique which is applied to techniques such as typical speaker recognition and speaker checking. As the speaker model, a model such as vector quantization (VQ) or Hiddern Markov Model (HMM) may be applied, and further, a specific speaker sound HMM obtained by applying a non-specific speaker model for phonemic recognition may be applied.

By the processing of the speaker similarity deriving section 102 based on control of the control mechanism 10, the association apparatus 1 calculates a probability P(B|A) of the voice data of the call B in the speaker model of the call A, and a probability P(A|B) of the voice data of the call A in the speaker model of the call B (S303). In calculation of the probability P(B|A) and the probability P(A|B) in Step S303, the speech recognition processing may be previously performed, and based on data of a section where pronunciation of the identical word/phrase is recognized, speaker models are created for respective words/phrases, to calculate the respective probabilities, so that respective probabilities may calculated. Subsequently, for example, the probabilities of the respective words/phrases are averaged, whereby to calculate the probability P(B|A) and the probability P(A|B) as results of Step S303.

By the process of the speaker similarity deriving section 102 based on control of the control mechanism 10, the association apparatus 1 derives an average value of the probability P(B|A) and the probability P(A|B) as the speaker similarity Rs (S304). Here, it is desirable to perform range adjustment (normalization) such that the speaker similarity Rs is held within the range of not smaller than 0 and not larger than 1. Further, considering the problem of calculation accuracy, a logarithmic probability obtained by taking a logarithmic value of the probability may be used. It is to be noted that in Step S304, the speaker similarity Rs may be calculated so as to be a value other than the average value of the likelihood P(B|A) and the likelihood P(A|B). For example, when the voice data of the call B is short, the confidence of the speaker model of the call B generated from the voice data of the call B may be considered as low, and the value of the probability P(B|A) may be taken as the speaker similarity Rs.

In addition, it is possible to derive the speaker similarity Rs of three voice data or more at once. For example, the speaker similarity Rs of the call A, the call B and a call C can be calculated in the following manner:

Ra={(P(B|A)+(PC|A)+P(A|B)+P(C|B)+P(A|C)+P(B|C)}/6

The foregoing speaker similarity deriving processing is performed on the assumption that one voice data includes only voices produced by one speaker. However, there are practically cases where one voice data includes voices produced by plural speakers. Those are, for example, a case where voices of an operator at the call center and the customer are included in one voice data, and a case where plural customers speak by turns. Therefore, in the speaker similarity deriving processing, it is preferable to take action to prevent deterioration in confidence of the speaker similarity Rs due to inclusion of voices of plural speakers in one voice data. The action to prevent deterioration in confidence is action to facilitate specification of a voice of one speaker, used for derivation of the speaker similarity, from one voice data.

One of methods for specifying a voice of one speaker as a target from voice data including voices of plural speakers is described. First, speaker clustering processing and speaker labeling processing on voice data are executed, to classify a speech section with respect to each speaker. Specifically, a speaker characteristic vector is created in each voice section separated by non-voice sections, and the created speaker characteristic vectors are clustered. A speaker model is created with respect to each of the clustered clusters, and is subjected to speaker labeling where an identifier is provided. In the speaker labeling, the largest probability of voice data in regard to each voice section is obtained, to decide an optimum speaker model, so as to decide a speaker to be labeled.

A call time period of each speaker whose voice data in regard to each voice section has been labeled is calculated, and voice data in regard to a speaker, whose calculated call time is not longer than a previously set lower-limit time, or a ratio of the call time in regard to whom with respect to the total call time is not longer than a previously set lower limit ratio, is removed from voice data for use in calculation of the speaker similarity. In such a manner, speakers with respect to voice data can be narrowed down.

Even when the speakers are narrowed down as described above, in a case where voices produced by plural speaker are included in one voice data, a speaker similarity of each speaker is derived. Namely, when the voice data of the call A includes voices of speakers SA1, SA2, . . . , and the voice data of the call B includes voices of speakers SB1, SB2, . . . , the speaker similarity Rs concerning the combination of the respective speakers [Rs (SAi, SBj): i=1, 2, . . . , j=1, 2, . . . ] is derived. Then, the maximum value or the average value of all speaker similarities Rs (SAi, SBj) is derived as the speaker similarity Rs.

It is to be noted that the speaker similarity Rs derived here indicates a speaker similarity concerning customers. Therefore, specifying a voice produced by the operator among voices of plural speaker can remove a section of the voice produced by the operator. An example of methods for specifying a voice produced by the operator is described. As described above, the speaker clustering processing and the speaker labeling processing on voice data are executed to classify a voice section with respect to each speaker. Then, a voice section including a word/phrase which is likely to be produced by the operator at the time of calling-in, for example, a set phase such as “Hello, this is Fujitsu Support Center” is detected. Subsequently, a speech section of a speaker labeled concerning voice data between voice sections including that set phrase is removed from voice data for use in calculation of the speaker similarity. It is to be noted that as for words/phrases as set words/phrases, for example, those previously recorded in the word/phrase list 105 are used.

Another example of specifying a voice produced by the operator is described. First, speaker clustering processing and speaker labeling processing are executed on all voice data recorded in the voice database 12a. Then, a speaker whose voice is included in plural voice data with a frequency being not smaller than a previously set prescribed frequency is regarded as the operator, and a vice section labeled concerning the speaker is removed from voice data for use in calculation of the speaker similarity.

It is to be noted that the operator is easily removed by taking a voice on the operator side and a voice on the customer side as respective voice data in different channels. However, even in a system where a voice on the customer side is recorded distinctly from a voice on the operator side, a channel on the reception side showing a voice on the customer side may include a voice on the operator as an echo, depending upon a recording method. The echo as thus described can be removed in such a manner that, with a voice on the operator side taken as a reference signal and a voice on the customer side taken as an observation signal, echo canceller processing is executed.

Moreover, a speaker model based on a voice produced by the operator is previously is created, and thereby a voice section involving the operator may be removed. Further, if the operator can be specified by means of a call time and a telephone table, adding such factors allows removal of a voice section in regard to the operator with further higher accuracy.

In the speaker similarity calculating processing executed by the association device 1, by use of the foregoing variety of methods in combination, a speaker similarity is derived based on a voice of one selected speaker with respect to one voice data in the case of the one voice data including voices of plural speakers. For example, when voices of the operator and the customer are included in voice data, the voice of the speaker as the customer can be selected, and a speaker similarity can be derived, so as to improve accuracy of association. In such a manner, the speaker similarity calculating processing is executed.

Next, association degree deriving processing to be executed as Step S104 of the basis processing and association processing to be executed as Step S105 of the same processing are described. The association degree deriving processing is processing of deriving an association degree Rc indicating the possibility that plural voice data, which are the voice data of the call A and the voice data of the call B here, are associated with each other, based on the requirement similarity Ry and the speaker similarity Rs. Further, the association processing is processing of comparing the derived association degree Rc with a previously set threshold Tc, and associating the voice data of the call A and the voice data of the call B in the case of the association degree Rc being not smaller than the threshold value.

The association degree Rc is derived as a product of the requirement similarity Ry and the speaker similarity Rs as shown in the following expression (4):

Rc=Ry×Rs (4)

where

Rc: association degree,

Ry: requirement similarity, and

Rs: speaker similarity.

Since the requirement similarity Ry and the speaker similarity Rs which are used in the expression (4) take values not smaller than 0 and not larger than 1, the association degree Rc derived by the expression (4) is also not smaller than 0 and not larger than 1. It is to be noted that as the threshold Tc to be compared with the association degree Rc, a value such as 0.5 is set.

It is to be noted that, as shown in the following expression (5), the association degree Rc may be derived as a weighted average value of the requirement similarity Ry and the speaker similarity Rs.

Rc=Wy×Ry+Ws×Rs (5)

where Wy and Ws are weighting factors satisfying: Wy+Ws=1.

When the sum of the weighting factors Wy, Ws is 0, the association degree Rc derived by the expression (5) is also a value not smaller than 0 and not larger than 1. Setting the weighting factors Wy, Ws in accordance with the confidences of the requirement similarity Ry and the speaker similarity Rs can derive the association degree Rc with high confidence.

The weighting factors Wy, Ws are set, for example, in accordance with the time length of voice data. When the time length of the voice data is large, the confidence of the speaker similarity Rs becomes high. Therefore, setting the weighting factors Wy, Ws as follows in accordance with shorter call time T (min) of the voice data of the call A and the voice data of the call B can improve the confidence of the association degree Rc.

Ws=0.3(T<10)

Ws=0.3+(T−10)×0.02(10≦T<30)

Ws=0.7(T≧30)

Wy=1−Ws

It is to be noted that the weighting factors Wy, Ws can be appropriately set based on a variety of factors other than the above, such as the confidence of speech recognition processing at the time of deriving the speaker similarity Rs.

Further, when one value out of the requirement similarity Ry and the speaker similarity Rs is low, the association degree Rc may be derived despite a derivation result obtained by the expression (4) or (5). Namely, even when either requirements or speakers are similar, it is considered unlikely that calls are a series of calls unless the others are also similar, whereby association due to derivation of the association degree Rc by the calculation expression is prevented. Specifically, when the requirement similarity Ry is smaller than a previously set threshold Ty, or when the speaker similarity Rs is smaller than a previously set threshold Ts, derivation is performed with the association degree Rc set to 0. In this case, abbreviating derivation of the association degree Rc in the expression (4) or (5) can reduce load of the processing performed by the association device 1.

Further, the association degree Rc may be adjusted in coordination with speech recognition processing in the requirement similarity deriving processing, when a specific word/phrase of voice data is included. For example, when a specific word/phrase indicating the continuation of a subject, such as “have called earlier”, “called yesterday”, or “the earlier subject”, “the subject on which you have called”, is included, voice data to be associated is likely to be present in voice data before that voice data. Therefore, when such specific word/phrase indicating the continuation is included, the association degree Rc is divided by a prescribed value such as 0.9 to adjust so as to become large, so that the confidence of association can improved. It should be noted that adjustment may not be made such that the association degree Rc becomes large, but may be made such that the threshold Tc is multiplied by a prescribed value such as 0.9, so as to be small. It is noted that, such adjustment is made in the case of detecting time in regard to voice data and determining association of voice data before voice data including a specific word/phrase. It should be noted that, in a case where a specific word/phrase indicating the subsequent continuation of a subject, such as “I will hung up once” or “I will call you back later”, is included, when association of voice data after the voice data including the specific word/phrase is determined, adjustment is made so as to make the association degree Rc large or the threshold Tc small. Such a specific word/phrase is mounted on the association device 1 as part of the word/phrase list 105.

Moreover, when voice data includes a specific word/phrase indicating the completion of a subject, such as “was reissued”, “confirmation was completed”, “processing was completed”, or “was dissolved”, is included, voice data to be associated is unlikely to be present in voice data after that voice data. Therefore, when such a specific word/phrase indicating the completion of a subject is included, adjustment is made so as to make the association degree Rc small, or the association degree Rc become 0 so that the confidence of association can be improved. It should be noted that the adjustment may not be made such that the association degree Rc becomes small, but may be made such that the threshold Tc becomes large. However, this kind of adjustment is made in the case of detecting the time in regard to voice data and determining association with respect to voice data after the voice data including the specific word/phrase. It is to be noted that, in a case where a specific word/phrase indicating the start of a subject is included, when association of voice data before the voice data including the specific word/phrase is determined, adjustment is made so as to make the association degree Rc small or the threshold Tc large.

Further, in a case where voice data includes a specific word/phrase indicating the subsequent continuation, it may be possible to predict, from a content of the specific word/phrase, a degree of elapsed time at which voice data to be associated is most likely to appear. In such a case, as shown in the following expression (6), a penalty function that changes as a time function is multiplied, to adjust the association degree Rc, so that the confidence of the association degree Rc can be improved.

Rc′=Rc×Penalty(t) (6)

where

Rc′: adjusted association degree Rc,

t: time after voice data including specific word/phrase, and

Penalty (t): penalty function.

It is to be noted that adjustment of the association degree Rc based on the penalty function is not limited to the adjustment shown in the expression (6). For example, adjustment of the association degree Rc based on the penalty function may be executed as in the following expression (7).

Rc′=max {Rc−(1−Penalty(t)), 0} (7)

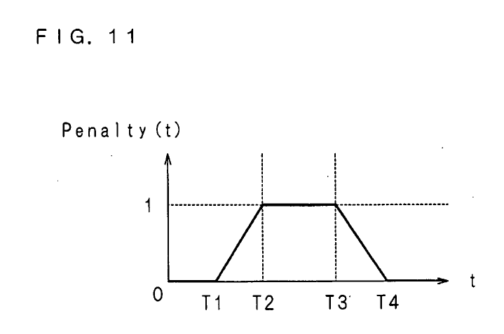

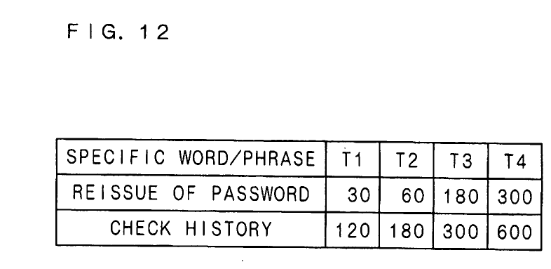

FIG. 11 is a graph showing an example of a time change of a penalty function in the association degree deriving processing performed by the association device 1 of the present embodiment, and FIG. 12 is a diagram showing a specific example of time used for the penalty function in the association degree deriving processing performed by the association device 1 of the present embodiment. In FIG. 11, with elapsed time period t after the completion a call in regard to voice data including a specific word/phrase taken as the axis of abscissas, and a penalty function taken as the axis of ordinate, the relation therebetween is shown. As shown in FIG. 11, the inclination of the penalty function changes with the elapsed times T1, T2, T3 and T4 as references. Namely, after the completion of a call in regard to the voice data including a specific word/phrase, a call to be associated appears in the time band between T2 and T3, but it may appear at T1 at the shortest interval, and at T4 at the longest interval. Such a time change of the penalty function can be shown as follows:

Penalty(t)=0 (t≦T1)

Penalty(t)=(t−T1)/(T2−T1) (T1<t<T2)

Penalty(t)=1 (T2≦t≦T3)

Penalty(t)=1−(t−T3)/(T4−T3) (T3<t<T4)

Penalty(t)=0 (T4≦t)

FIG. 12 shows specific examples of T1, T2, T3 and T4 shown in FIG. 11. For example, when voice data includes a specific word/phrase “will reissue a password”, each numeric value is set based on the assumption that a call to be associated is likely to appear 60 to 180 seconds after the completion of the call in regard to the voice data, and the call to be associated is very unlikely to appear 30 seconds before or 300 seconds later. It should be noted that the specific word/phrase may not be corresponded to numeric values of T1, T2, T3 and T4, but may be associated with a requirement, and the requirement may further be associated with the numeric values, so as to derive T1, T2, T3 and T4 from the specific word/phrase. Moreover, the buffering periods such as the period between T1 and T2 and the period between T3 and T4 may not be provided, but Rc may be set to 0 when the time change deviates from the range of the time when association is performed from the specific word/phrase.

Further, the penalty function may be set which changes not with relative time after the completion of a call in regard to the voice data including a specific word/phrase, but with absolute date and time as a function. For example, when a specific word/phrase indicating a time period of a next call, such as “will contact you at about 3 o'clock”, or “will get back to you tomorrow”, is included, the penalty function that changes with a date and time as a function is used.

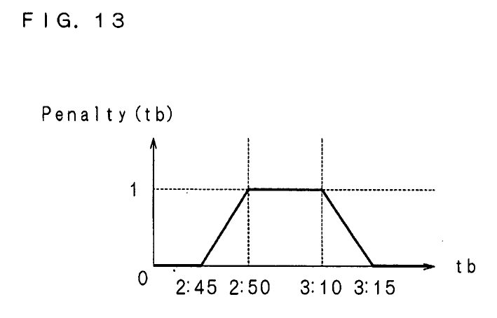

FIG. 13 is a graph showing an example of a time change of a penalty function in the association degree deriving processing performed by the association device 1 of the present embodiment. In FIG. 13, with start time tb of a call taken as the axis of abscissas, a penalty function taken as the axis of ordinate, the relation therebetween is shown. FIG. 13 shows a value of the penalty function set based on the specific word/phrase of “will contact you at about three o'clock”. It should be noted that the foregoing expression (6), (7) or the like is used for adjustment of the association degree Rc based on the penalty function.

Moreover, when the call A and the call B temporally overlap, a variety of adjustments, such as setting the association degree Rc to 0, are made.

The foregoing embodiment merely exemplifies part of a large number of embodiments, and configurations of a variety of hardware, software, and the like, can be appropriately set. Further, a variety of setting can also be made in accordance with a mounting mode for improving accuracy of association according to the present technique.

For example, a global model may be previously created from a plurality of voice data in regard to past calls of plural speakers, and a speaker similarity is normalized by means of a probability ratio to the global model, so as to improve accuracy of the speaker similarity, and further accuracy of association.

Further, plural voice data in regard to past calls of plural speakers may be previously subjected to hierarchical clustering by speaker, a model of a speaker close to a vector of a speaker during a call may be taken as a cohort model, and the speaker similarity is normalized by means of a probability ratio to the cohort model, so as to improve accuracy of the speaker similarity, and further accuracy of association.

Further, plural voice data in regard to past calls of plural speakers may be previously subjected to hierarchical clustering by speaker, and which cluster is close to a vector of a speaker currently in call may be calculated, so as to narrow down an object for derivation of the speaker similarity.

Further, in a case where a requirement word/phrase that shows speaker replacement is included in voice data, an association degree may be derived only by means of a requirement similarity.

Further, during a call or at the completion of a call, information showing continuity such as “not completed (will call back later)”, “continued (will be continued to a subsequent call)” or “single (cannot associated with other voice data)” may be inputted into a prescribed device, and the information showing continuity may be recorded in correspondence with voice data, so as to improve accuracy of association. Moreover, a speaker model may be created and recorded at each completion of a call. However, when information indicating “single” is corresponded, it is desirable, from the view point of resource reduction, to make use of a speaker model so as to discard the model.

According to the disclosed contents, an association degree is derived from a word/phrase similarity based on an appearance ratio of a common word/phrase and a speaker similarity derived based on characteristics of voices, and whether or not to associate voice data is determined based on the association degree, whereby it is possible to associate a series of voice data based on a requirement and a speaker. Further, in specification of the speaker, notification of a caller number is not required, and further, plural peoples in regard to the same call number can be differentiated.

The present disclosure includes contents of: deriving a numeric value in regard to an appearance ratio of a common word/phrase that is common among the voice data as a common similarity based on a result of speech recognition processing on the voice data; deriving a similarity indicating a result of comparing characteristics of respective voices extracted from the voice data converted from voices produced by speakers as a speaker similarity; deriving an association degree indicating the possibility of plural voice data being associated with one another based on the derived word/phrase similarity and speaker similarity; comparing the derived association degree with a set threshold, to associate plural voice data with one another, the association degree of which is not smaller than the threshold.

With this configuration, excellent effects can be exerted, such as an effect of allowing association of a series of voice data on a continued requirement based on words/phrases and speakers. Further, in specification of the speaker, notification of a caller number is not required, and further, plural peoples in regard to the same call number can be differentiated.

As this description may be embodied in several forms without departing from the spirit of essential characteristics thereof, the present embodiments are therefore illustrative and not restrictive, since the scope of the description is defined by the appended claims rather than by description preceding them, and all changes that fall within metes and bounds of the claims, or equivalence of such metes and bounds thereof are therefore intended to be embraced by the claims.

What is claimed is:

1. An association apparatus for associating a plurality of voice data converted from voices produced by speakers, comprising:
a word/phrase similarity deriving section which derives an appearance ratio of a common word/phrase that is common among the voice data based on a result of speech recognition processing on the voice data, as a word/phrase similarity;
a speaker similarity deriving section which derives a result of comparing characteristics of voices extracted from the voice data, as a speaker similarity;
an association degree deriving section which derives a possibility of the plurality of the voice data, which are associated with one another, based on the derived word/phrase similarity and the speaker similarity, as an association degree; and
an association section which associates the plurality of the voice data with one another, the derived association degree of which is equal to or more than a preset threshold.

2. The apparatus according to claim 1, wherein
the word/phrase similarity deriving section modifies a word/phrase similarity based on at least either
confidence of the speech recognition processing, or
a time period between a start time point of a voice section included in voice data and a time point when the common word/phrase appears.

3. The apparatus according to claim 1, wherein
the speaker similarity deriving section derives a speaker similarity based on a voice of one speaker when voices of speakers are included in the voice data.

4. The apparatus according to claim 2, wherein
the speaker similarity deriving section derives a speaker similarity based on a voice of one speaker when voices of speakers are included in the voice data.

5. The apparatus according to claim 1,
wherein the association degree deriving section weight averages a word/phrase similarity and a speaker similarity and thus derives an association degree, and
wherein the association degree deriving section further changes a weighting factor based on a time length of a voice in regard to the voice data.

6. The apparatus according to claim 2,
wherein the association degree deriving section weight averages a word/phrase similarity and a speaker similarity and thus derives an association degree, and
wherein the association degree deriving section further changes a weighting factor based on a time length of a voice in regard to the voice data.

7. The apparatus according to claim 3,
wherein the association degree deriving section weight averages a word/phrase similarity and a speaker similarity and thus derives an association degree, and
wherein the association degree deriving section further changes a weighting factor based on a time length of a voice in regard to the voice data.

8. The apparatus according to claim 4,
wherein the association degree deriving section weight averages a word/phrase similarity and a speaker similarity and thus derives an association degree, and
wherein the association degree deriving section further changes a weighting factor based on a time length of a voice in regard to the voice data.

9. The apparatus according to claim 1, wherein
the association section
determines whether or not the voice data include a specific word/phrase indicating start of a subject, completion of a subject or continuation of a subject based on the result of the speech recognition processing on the voice data, and
modifies the association degree or the threshold when it is determined that the specific word/phrase is included.

10. The apparatus according to claim 1, wherein
the voice data include time data indicating time, and
the association degree deriving section or the association section excludes plural voice data to become objects for association out of objects for association when time periods of plural voice data to become objects for association mutually overlap.

11. An association method using an association apparatus for associating a plurality of voice data converted from voices produced by speakers, comprising:
deriving an appearance ratio of a common word/phrase that is common among the voice data as a word/phrase similarity based on a result of speech recognition processing on the voice data;
deriving a result of comparing characteristics of voices extracted from the voice data as a speaker similarity;
deriving an association degree indicating a possibility of the plurality of the voice data, which are associated with one another, based on the derived word/phrase similarity and the speaker similarity; and
associating the plurality of the voice data with one another, the derived association degree of which is equal to or more than a preset threshold.

12. The method according to claim 11, wherein
the step of deriving a word/phrase similarity includes modifying a word/phrase similarity based on at least either
confidence of the speech recognition processing, or
a time period between a start time point of a voice section included in voice data and a time point when a common word/phrase appears.

13. The method according to claim 11, wherein
the step of deriving an association degree includes
deriving a speaker similarity based on a voice of one speaker when voices of plural speakers are included in voice data.

14. The method according to claim 11, wherein
the step of deriving an association degree includes:
weight averaging a word/phrase similarity and a speaker similarity, and thus deriving an association degree; and
changing a weighting factor based on a time length of a voice in regard to the voice data.

15. The method according to claim 11, wherein
the step of associating includes:
determining whether or not voice data include a specific word/phrase indicating start of a subject, completion of a subject or continuation of a subject based on the result of the speech recognition processing on the voice data; and
modifying of the association degree or the threshold when it is determined that the specific word/phrase is included.

16. The method according to claim 11, wherein
the voice data includes time data indicating time, and
the step of deriving an association degree includes
excluding plural voice data to become objects for association out of objects for association when time periods of plural voice data to become objects for association mutually overlap.

17. The method according to claim 11, wherein
the voice data includes time data indicating time, and
the step of associating includes
excluding plural voice data to become objects for association out of objects for association when time periods of plural voice data to become objects for association mutually overlap.

18. A computer-readable recording medium in which a computer-executable computer program is recorded and causes a computer to associate a plurality of voice data converted from voices produced by speakers, the computer program comprising:
causing the computer to derive an appearance ratio of a common word/phrase that is common among the voice data as a word/phrase similarity based on a result of speech recognition processing on the voice data;
causing the computer to derive a result of comparing characteristics of voices extracted from the voice data as a speaker similarity;
causing the computer to derive an association degree indicating a possibility of the plurality of the voice data, which are associated with one another, based on the derived word/phrase similarity and the speaker similarity; and
causing the computer to associate the plurality of the voice data with one another, the derived association degree of which is equal to or more than a preset threshold.
